(19) United States
(12) Patent Application Publication
(10) Pub. No.: US 2022/0025270 A1
(43) Pub. Date: Jan. 27, 2022

(54) BIOMASS PROCESSING DEVICES, SYSTEMS, AND METHODS

(71) Applicant: EnerSysNet U.S. Holdings, Inc., Millinocket, ME (US)

(72) Inventors: Gary E. Scoggins, Kent, WA (US); James M. Colthart, Boca Grande, FL (US); Paul F. Bryan, Pinole, CA (US); Charles Robert Rapier, Chandler, AZ (US)

(21) Appl. No.: 17/498,700

(22) Filed: Oct. 11, 2021

Related U.S. Application Data
(62) Division of application No. 16/530,560, filed on Aug. 2, 2019, now abandoned.
(60) Provisional application No. 62/714,386, filed on Aug. 3, 2018.

(51) Int. Cl. C10B 53/02; C10B 7/10; C10B 47/44; C10J 3/62

(52) U.S. Cl. CPC C10B 53/02; C10B 7/10; C10J 2300/0916; C10J 3/62; C10B 47/44

(57) ABSTRACT

Biomass processing devices, systems and methods used to convert biomass to, for example, liquid hydrocarbons, renewable chemicals, and/or composites are described. The biomass processing system can include a pyrolysis device, a hydroprocessor and a gasifier. Biomass, such as wood chips, is fed into the pyrolysis device to produce char and pyrolysis vapors. Pyrolysis vapors are processed in the hydroprocessor, such as a deoxygenation device, to produce hydrocarbons, light gas, and water. Water and char produced by the system can be used in the gasifier to produce carbon monoxide and hydrogen, which may be recycled back to the pyrolysis device and/or hydroprocessor.

### CROSS-REFERENCE TO RELATED APPLICATION(S)

The present application is a divisional application of U.S. patent application Ser. No. 16/530,560, filed on Aug. 2, 2019, which claims the benefit of priority to U.S. Provisional Patent Application No. 62/714,386, filed Aug. 3, 2018, the disclosures of which are incorporated herein by reference in their entireties.

### TECHNICAL FIELD

The present technology generally relates to biomass processing devices, systems and methods used to convert biomass to, for example, liquid hydrocarbons, renewable chemicals, and/or composites.

### BACKGROUND

As atmospheric carbon dioxide levels continue to rise, efforts to produce carbon-neutral and/or reduced-carbon fuels have increased exponentially. Innovations in wind, solar, tidal, and other energy sources are continually developed as alternatives to traditional fossil-based fuels.

Another abundant source of fuel is the biomass found in forests and other natural environments. Biomass is an abundant fuel source found in many regions and topographies around the world. However, converting this biomass (e.g., vegetation, wood, etc.) has faced many challenges. For example, converting biomass to fuel is often inefficient, with little of the constituent components of the biomass being converted to usable fuel. Additionally, challenges arise with respect to converting biomass into a fuel that is usable by existing systems and devices, including vehicles, utilities, and other fuel-using systems. Other challenges are logistical. For example, abundant sources of biomass tend to be found in remote or semi-remote locations. In order to reduce the energy costs of shipping the biomass to a more convenient location (e.g., a fixed conversion plant or other immovable structure), it is desirable that the biomass be collected and converted in locations where biomass is presently in abundance.

Accordingly, a need exists for devices, systems and methods of processing biomass that address some or all of the problems discussed above.

### BRIEF DESCRIPTION OF THE DRAWINGS

Many aspects of the present technology can be better understood with reference to the following drawings. The components in the drawings are not necessarily to scale. Instead, emphasis is placed on illustrating clearly the principles of the present technology.

FIG. 1 is a schematic illustration of an embodiment of a biomass processing system.

FIG. 2 is a schematic illustration of another embodiment of a biomass processing system.

FIG. 3 is schematic illustration of another embodiment of a biomass processing system.

FIG. 4 is a schematic illustration of another embodiment of a biomass processing system.

FIG. 5 is a schematic illustration of a pyrolysis device, including an auger, for use with a biomass processing system.

FIG. 6 is a side plan view of an auger for use with a pyrolysis device of a biomass processing system.

FIG. 7 is a longitudinal cross-section view of the auger of FIG. 6, taken along the cut-plane A-A of FIG. 6.

FIG. 8 is a side plan view of a deoxygenation device for use in a biomass processing system.

FIGS. 9A and 9B are a longitudinal cross-section view and a transverse cross-section view, respectively, of a portion of a catalyst bed of a deoxygenation device for use in a biomass processing system.

### DETAILED DESCRIPTION

Specific details of several embodiments of biomass processing systems, as well as associated systems and methods, are described below. Generally, the biomass processing systems of the present disclosure include a pyrolysis device. This device can include an intake configured to receive biomass (e.g., chipped wood and/or other vegetation). The pyrolysis device can be configured to receive and process biomass without the need to pre-treat the biomass. For example, the pyrolysis device can receive wood chips as output by a standard wood chipper without the need for further size reduction to the wood chips. The pyrolysis device can be configured to output pyrolysis vapors and char (e.g., biochar) at elevated pressures.

The biomass processing system can further include a hydroprocessing unit (e.g., deoxygenation reactor) configured to process the vapors and/or char. In some embodiments, the hydroprocessing unit can convert the vapors to usable hydrocarbons. This hydroprocessing can take place without the need for intermediate conversion of the hydrocarbons to bio-oil or other intermediate products.

In some embodiments, the biomass processing systems of the present disclosure can include one or more gasification units configured to facilitate conversion of reaction constituents (e.g., CO₂, H₂O, char, etc.) into usable/desired constituents (e.g., H₂, CO, hydrocarbons, etc.).

In some embodiments, the biomass processing system of the present disclosure is a remote biomass processing system capable of operating in remote locations and of being moved to additional locations as desired. Such a system can be configured to operate “off the grid” such that existing electrical, water, or other utility systems are not required to operate the biomass processing system. Preferably, the biomass processing systems are configured to operate with little or no additional fuel or other inputs, other than the locally-sourced biomass.

Preferably, the biomass processing systems of the present disclosure, and specifically the remote biomass processing systems, are relatively small. For example, the systems can have a footprint less than 200 square feet, less than 240 square feet, less than 300 square feet, and/or less than 400 square feet. The systems can be capable of throughput rates of at least 2 tons per day, at least 3 tons per day, at least 4 tons per day, at least 6 tons per day, and/or at least 8 tons per day of biomass. In some embodiments, the systems are configured to output at least 150 gallons, at least 200 gallons, at least 300 gallons, and/or at least 400 gallons of usable hydrocarbons per day.

### Biomass Processing Systems

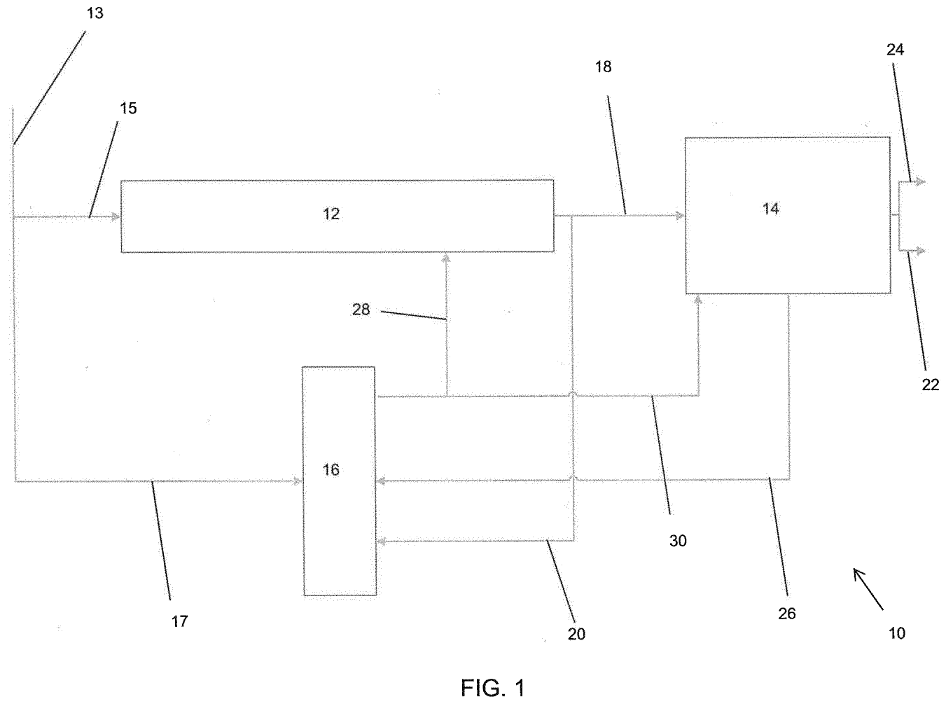

FIG. 1 provides a schematic illustration of an embodiment of biomass processing system 10. The system 10 can generally include a pyrolysis device 12, a hydroprocessor (e.g., de-oxygenator or hydrodeoxygenation unit (HDU)) 14, and/or a gasifier 16. Various mass transfer pathways can extend between the various components to facilitate movement of materials between units and devices of the system 10.

The pyrolysis device 12 can include, for example, an auger configured to process wood biomass 13. Exemplary biomass that can be introduced into pyrolysis device 12 includes, but is not limited to, wood chips and saw dust. In some embodiments, the biomass is treated prior to introduction into the pyrolysis device 12 in order to reduce the moisture content of the biomass. In some embodiments, the biomass is treated to reduce the moisture content to 10 wt % or less. As discussed in more detail with respect to later embodiments, the auger can be tapered such that a hub of the auger increases in size from an inlet end to an outlet end of the pyrolysis device 12. As also discussed in more detail with respect to later embodiments, the pyrolysis device 12 can include a seal between the inlet receiving a first portion 15 of biomass 13 and the outlet of the pyrolysis device 12. A second portion 17 of biomass 13 can be directed to, for example, the gasifier 16.

The pyrolysis device 12 operates to convert biomass to pyrolysis vapors and/or char through the application of heat and/or pressure. Any suitable heat and/or pressure parameters can be used in the pyrolysis device 12 provided that biomass is converted to pyrolysis vapors and/or char. The pyrolysis device 12 can output pyrolysis vapors and/or char, at which point the output material can be separated. For example, pyrolysis vapors can be separated from char such that pyrolysis vapors (or predominantly pyrolysis vapors) are transported to the hydroprocessor 14 via transfer path 18, while char (or predominantly char) is diverted away from the hydroprocessor 14 via transfer path 20. Any and all transfer paths discussed herein, including transfer paths 18, 20 can include one or more pipes, tube, and/or other channels or conduits. Similarly, any transfer paths discussed herein can include one or more valves that are positioned therein. The valves can be check valves configured to open at a minimum cracking pressure. In some embodiments, the valves are solenoid valves or other valves configured to be controlled (e.g., via a controller) to transition between opened and closed configurations.

The hydroprocessor 14 can be configured to convert the pyrolysis vapors produced by the pyrolysis device 12 into usable substances. For example, the hydroprocessor 14 can include one or more catalysts positioned within the hydroprocessor 14. In some embodiments, catalyst is coated on various internal surfaces of the hydroprocessor 14. In some embodiments, catalyst is loaded in tubes extending through the hydroprocessor 14. These catalysts, discussed in more detail below, can be configured to process the pyrolysis vapors to produce a mixture of water, hydrocarbons, and/or light gases. In some embodiments, the hydroprocessor 14 is configured to process the pyrolysis vapors at elevated pressure and temperature without needing to condense the vapors prior to processing. Preferably, the product mixture resulting from the hydroprocessing carried out in the hydroprocessor 14 is immiscible, allowing for easy separation (e.g., via siphoning) of the hydrocarbons, water, and light gases from each other.

As further illustrated in FIG. 1, the product mixture produced by the hydroprocessor 14 can be subjected to separation to form a water stream, a hydrocarbon stream and a light gas stream. The hydrocarbon stream can be output from the hydroprocessor 14 via an output path 22. The output path 22 can direct the hydrocarbons to a storage tank, to a further processing device, and/or to one or more components of the biomass processing system 10. The light gases can be directed from the hydroprocessor 14 via a second output path 24. The second output path 24 from the hydroprocessor 14 can direct the light gases to a storage tank. In some embodiments, the light gases and/or hydrocarbons are used to operate other components of the biomass processing system 14. For example, the light gases or hydrocarbons can be used to operate an internal combustion engine or other mechanism configured to operate the pyrolysis device 12. In some embodiments, the light gases or hydrocarbons are used to heat the pyrolysis device 12 (e.g., via a heat sleeve, molten salt loop, electric heat sleeve, or other heating mechanism).

While a portion of the output of the pyrolysis device 12 (e.g., pyrolysis vapors) can be directed to the hydroprocessor 14 via transfer path 18, another portion of the output of the pyrolysis device 12 (e.g., char) can be directed to a gasifier 16 via transfer path 20. As noted previously, the output content from pyrolysis device 12 can be selectively directed to the transfer paths 18, 20 via use of filters and/or valves to reduce the amount of char directed to the hydroprocessor 14 while reducing the amount of vapor directed to the gasifier 16.

In some embodiments, the water produced by the hydroprocessor 14, or at least a portion thereof, is directed to the gasifier 16 via transfer pathway 26. The gasifier 16 can be configured to use the water from the hydroprocessor 14, the char from the pyrolysis device 12, and/or biomass (e.g., the second portion 17 of biomass directed to the gasifier 16) to produce desired chemical compounds. For example, the gasifier 16 can be configured to output CO to the pyrolysis device 12 via transfer path 28 to increase the efficiency of the pyrolysis device 12. In some embodiments, the gasifier 16 produces hydrogen that is output to the hydroprocessor 14 via transfer path 30 to increase the efficiency (e.g., amount of hydrocarbon production) of the hydroprocessor 14.

As shown in FIG. 1, water output by the hydroprocessor 14 and carbon monoxide and hydrogen output by the gasifier 16 are reused in the overall process, which results in improved C and H efficiency.

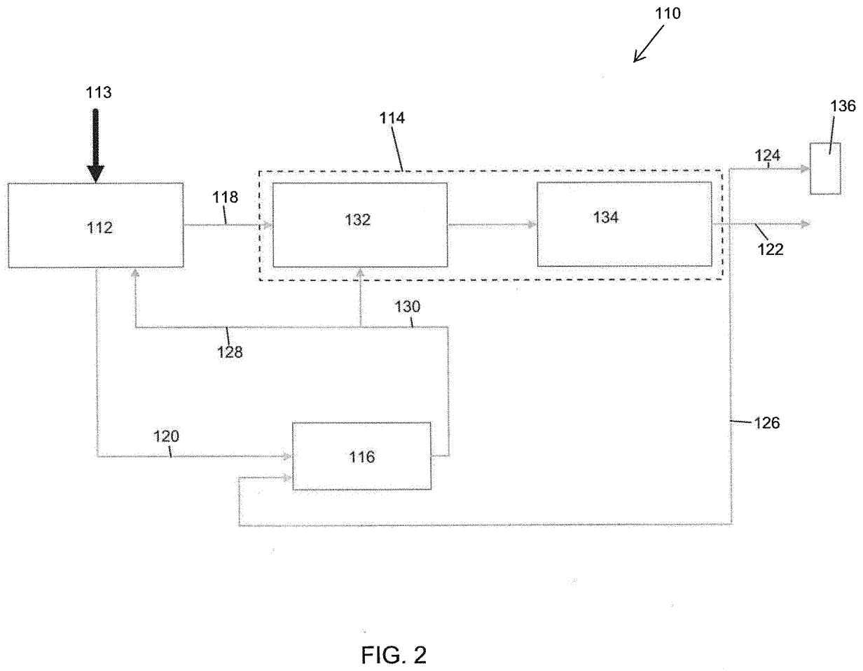

FIG. 2 illustrates an embodiment of a biomass processing system 110 that is similar to or the same as the biomass processing system 10 in several aspects. For example, the biomass processing systems 110, 10 can be similar to each other in one or both of structure and function. In the proceeding description, like numbers (e.g., pyrolysis device 12 vs. pyrolysis device 112, wherein the last two digits in the reference number are shared) are used to denote features that can be similar or the same between the two biomass processing systems 10, 110.

As illustrated in FIG. 2, the hydroprocessor 114 can include a deoxygenation device 132. The deoxygenation device 132 can be configured to receive the pyrolysis vapors from the pyrolysis device 112 via the transfer path 118. The deoxygenation device 132 can include one or more catalysts embedded in, coated on, or otherwise associated with the deoxygenation device 132. The deoxygenation device 132 can be configured to receive hydrogen and/or some other compound from the gasifier 116 or other source to aid in the deoxygenation of the pyrolysis vapors received from the pyrolysis device 112. Generally speaking, the deoxygenation process carried out by the deoxygenation device 132 rejects oxygen by making water. The deoxygenation device 132 also enables deoxygenation to hydrocarbons in the vapor phase.

The hydroprocessor 114 can also include a condenser 134 or other component (e.g., a container, fluid separator, or other device) configured to receive the output from the deoxygenation device 132. The condenser 134 can condense the output water, light gas, and/or hydrocarbons from the deoxygenation device 132. Preferably, the output constituents from the deoxygenation device 132 are immiscible and easily separated into their respective parts (e.g., water, light gas or hydrocarbons). The light gases can be output to a combined heat and power (CHP) system 136 via the transfer path 124. The water can be recycled back to the gasifier 116 via the transfer path 126. In some embodiments, the hydrocarbons are transferred to a storage container or to some other component of the system 110 via the transfer path 122. The condenser 134 operates to ensure no loss of carbon to phase separation or bio-oil re-vaporization.

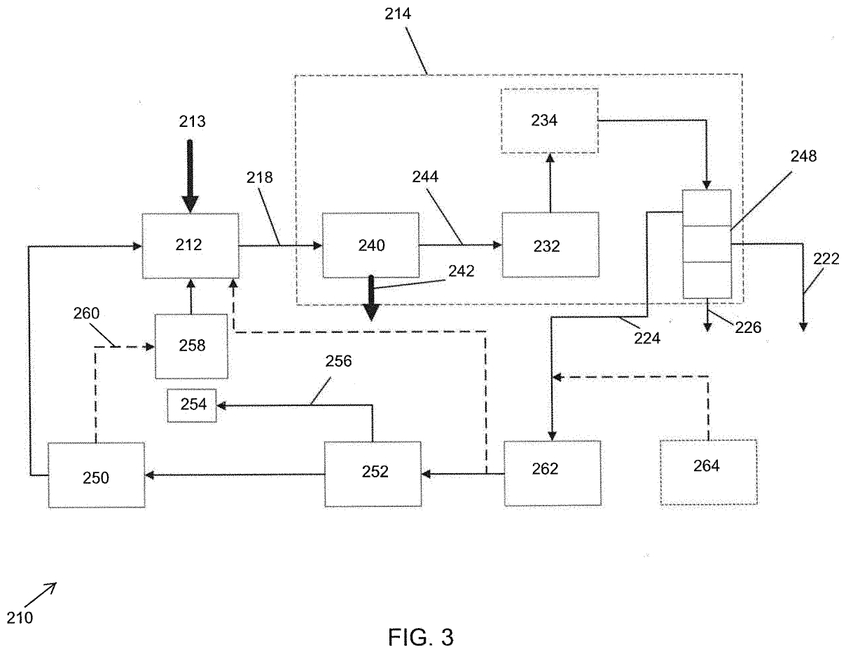

FIG. 3 illustrates an embodiment of a biomass processing system 210 that is similar to or the same as the pyrolysis systems 10, 110 in several aspects. For example, the biomass processing systems 210, 110, 10 can be similar to each other in one or both of structure and function. In the proceeding description, like numbers (e.g., pyrolysis device 12 vs. pyrolysis device 112 vs. pyrolysis device 212, wherein the last two digits in the reference number are shared) are used to denote features that can be similar or the same between the biomass processing systems 10, 110, 210.

As illustrated in FIG. 3, the hydroprocessor 214 can include a filter device 240. The filter or separator device 240 is configured to separate pyrolysis vapors from char, both of which are received from the pyrolysis device 212 via the transfer path 218. As will be explained in further detail below, one or more components of the hydroprocessor 214 are configured to operate in the presence of char. As such, complete filtering of the char from the pyrolysis vapor is not required for all embodiments. After separating (at least partially) the char from the pyrolysis vapor, the filter device 240 is configured to output char (or predominantly char) via a transfer path 242 and to output pyrolysis vapor (or predominantly pyrolysis vapor) via a second transfer path 244. The transfer path 242 for char from the filter device 240 can lead to a container. In some embodiments, the char from the filter device 240 is directed to a gasifier or other component for use in chemical reactions, as discussed in further detail below.

The hydroprocessor 214 can optionally include a condenser 246. The condenser 246 can be configured to condense the mixture (e.g., water, hydrocarbons, and/or light gases) received from the deoxygenation device 232. The condensed mixture can be directed to a separation device 248 configured to separate the constituents of the mixture. The separation device can be configured to output water via a transfer path 222 and to output hydrocarbons via a second transfer path 226. The separation device 248 can output fuel gases (e.g., light gases) via a third transfer path 224. The water and/or hydrocarbons can be directed to other components of the system 210 for use as fuel and/or in chemical reactions.

In some embodiments, the fuel gases, or some portion thereof, are directed to an actuator 250. The actuator 250 can be configured to operate the pyrolysis device 212 (e.g., to rotate the auger). Example actuators 250 include internal combustion engines, electric motors, turbomachinery, or other mechanisms configured to provide power to the pyrolysis device 212. In some embodiments, fuel gas is directed to a generator configured to provide electric power to the actuator 250 and/or to provide power to other components of the system 210.

The pyrolysis system 210 can include a fuel gas reservoir 252 configured to retain fuel gas provided by the hydroprocessor 214 prior to its use in the actuator 250. In some embodiments, the fuel gas reservoir 252 is at least partially filled using conventional fossil fuels or other fuels not produced by the system 210 to provide initial or supplemental energy to the system 210.

At least a portion of the fuel gas stored in reservoir 252 can be directed to a burner 254. As illustrated in FIG. 3, in some embodiments the fuel gas is provided to the burner 254 via a transfer path 256 from the fuel gas reservoir 252. The burner 254 can be configured to burn the fuel gas to provide heat to a heat pipe 258 or other heating mechanism. The heat pipe 258 can be configured to provide heat to the pyrolysis device 212. For example, the heat pipe 258 can provide heat to a portion of the pyrolysis device 212 along a length of the pyrolysis device 212. The heat can be directed around all or a portion of an outer surface of the pyrolysis device 212 along at least a portion of the length of the pyrolysis device 212. In some embodiments, heat from the heat pipe 258 heats a jacket surrounding a portion of the pyrolysis device 212. In some embodiments, exhaust gases 260 from the actuator 250 can also be directed to the heat pipe 258 to supplement the heat provided to the pyrolysis device 212. In some embodiments, an electric heater can be used in addition to or instead of the heat pipe 258. The electric heater can surround a portion of the pyrolysis device 212 along a portion of the length of the pyrolysis device 212.

In some embodiments, the biomass processing system 210 includes a fuel processor 262 upstream of the actuator 250 and/or reservoir 252. In some embodiments, the fuel processor 262 can be positioned between (e.g., physically between and/or in the fluid path between) the fuel gas reservoir 252 and the separation device 248. The fuel processor 262 can be, for example, a gasifier and/or a device having a hydrogen separation membrane or other structure configured to separate hydrogen from the fuel gas. The fuel processor 262 can be configured to direct separated hydrogen to the pyrolysis device 212 to bolster pyrolysis of the biomass in the pyrolysis device 212. In some embodiments, the biomass processing system 210 includes a secondary source of hydrogen 264 configured to provide hydrogen to the separation device 262 and/or to the pyrolysis device 212.

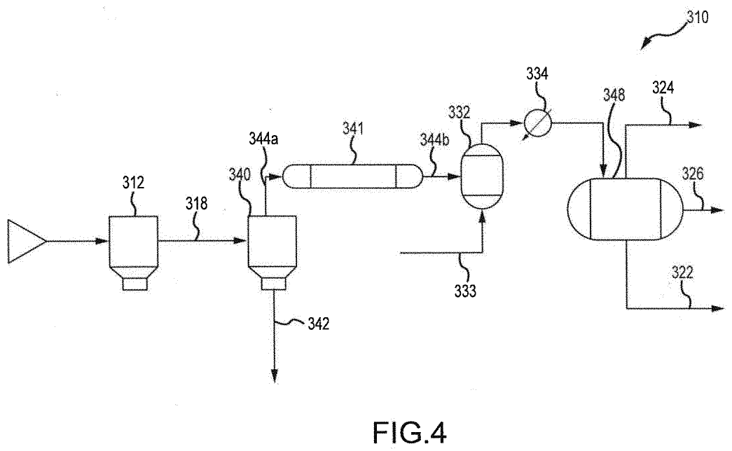

FIG. 4 illustrates an embodiment of a biomass processing system 310 that is similar to or the same as the pyrolysis systems 10, 110, 210 in several aspects. For example, the biomass processing systems 310, 210, 110, 10 can be similar to each other in one or both of structure and function. In the proceeding description, like numbers (e.g., pyrolysis device 12 vs. pyrolysis device 112 vs. pyrolysis device 212 vs. pyrolysis device 312, wherein the last two digits in the reference number are shared) are used to denote features that can be similar or the same between the biomass processing systems 10, 110, 210, 310.

As illustrated in FIG. 4, a first separation unit 340 in the form of a cyclone is provided for separating pyrolysis vapor and char. The cyclone 340 receives the product of the pyrolysis unit 312 via transfer path 318 and separates the pyrolysis vapor from the char using, e.g., centrifugal force. The char exits the cyclone 340 via transfer path 342, while pyrolysis vapors are transported via transfer path 344a to a second separation unit 341 in the form of a sulfur guard bed. The sulfur guard bed 341 removes sulfur from the pyrolysis vapor to achieve near zero sulfur content in the pyrolysis vapor. The scrubbed pyrolysis vapor is then transported to the deoxygenation device 332 via transfer path 344b. Hydrogen source 333 is provided so as to supply additional hydrogen to the deoxygenation device 332. The hydrogen 333 is provided at a partial pressure, and in conjunction with catalysts included within the deoxygenation device 332, work to optimize selectivity and yield.

### Pyrolysis Device and Auger

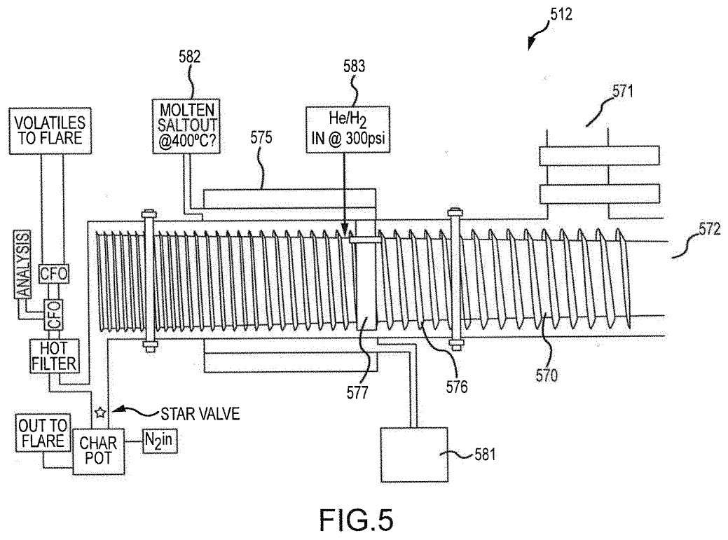

FIG. 5 illustrates an embodiment of a pyrolysis device 512. Any or all of the pyrolysis devices 12, 112, 212, 312 can share all or some of the features of the pyrolysis device 512. As illustrated, the pyrolysis device 512 can include an auger 570. The auger 570 can have an inlet end 572 and an outlet end 574. The core of the auger 570 can be outwardly tapered from the inlet end 572 toward the outlet end 574. The auger 570 can include a blade 576 wrapped around the core (e.g., in a helical pattern). The blade 576 can have a blade height as measured from the core in a direction perpendicular to the rotational axis of the core. The height of the blade 576 can vary from the inlet end 572 to the outlet end 574 of the auger 570. For example, the height of the blade 576 can decrease between the inlet end 572 and the outlet end 574. In some embodiments, the height of the blade 576 between the inlet and outlet ends 574 can decrease at a rate proportional to the increase in diameter of the core of the auger 570 such that a distance between the outer tip of the blade 576 (e.g., as measured from the rotational axis of the auger 570) and the rotational axis of the auger 570 is substantially constant along the length of the auger 570.

A heater 575 can be positioned around a portion of the auger 570 between the feed inlet 571 and the outlet of the pyrolysis device 512. In the illustrated example, the heater 575 is an electric band heater. As explained with respect to previous embodiments, the heater 575 can be a heat jacket, a heat pipe, and/or any other structure or method for heating all or a portion of the pyrolysis device 512. Preferably, the heater 575 completely surrounds a portion of a length of the pyrolysis device 512 (e.g., the auger 570). In some embodiments, molten salt can be used instead of or in addition to a heater 575 to provide heat to the pyrolysis device 512. The molten salt can be introduced via a molten salt inlet 581 at a first temperature to the pyrolysis device 512 and can leave the pyrolysis device 512 via a molten salt outlet 582 at a second, lower temperature. The first temperature can be, for example, at least 300° C., at least 400° C., at least 500° C., at least 600° C., and/or at least 800° C. The second temperature can be less than or equal to 900° C., less than or equal to 800° C., less than or equal to 600° C., less than or equal to 400° C., and/or less than or equal to 200° C. In some embodiments, the molten salt is provided by a gasifier.

During operation of the pyrolysis device 512, a seal 577 can be formed at a point along the length of the auger 570. More specifically, as the biomass transitions from biomass material to pyrolysis vapor and char, the biomass goes through a transition phase. Due at least in part to the thermoplastic nature of the biomass, the transitioning biomass between the inlet and the outlet of the pyrolysis device 512 forms a high-pressure seal 577 (e.g., a “melt” seal) capable of supporting high pressure within the pyrolysis device 512 between the seal 577 and the outlet of the pyrolysis device 512. These high pressures can be at least 300 psia, at least 400 psia, at least 500 psia, at least 1,000 psia, and/or at least 2,000 psia. At the same time, the operating pressure at the inlet 571 and upstream of the pressure seal 577 can be substantially equivalent to atmospheric pressure (e.g., between approximately 14-15 psia), which can allow for direct feeding of the biomass into the pyrolysis device 512 without need for valves or other pressure-maintenance mechanism at the inlet 571. Use of the biomass to form a seal 577 can reduce or eliminate the need for additional seals or other pressure-increasing or pressure-maintenance mechanisms in the upstream portion of the auger 570. In some applications, the pressure seal 577 eliminates the need for a compressor or other mechanism to increase the pressure within the pyrolysis device 512. Preferably, the melt seal 577 is gradually ablated and replenished during normal operation of the auger 570. For example, as a downstream side of the melt seal 577 is ablated, an upstream side of the melt seal 577 is replenished from biomass upstream of the seal 577.

In some embodiments, the melt seal 577 is located at or near an upstream end of the heater 575. In some embodiments, the melt seal 577 is positioned between the upstream and downstream ends of the heater 575. In some embodiments, the melt seal 577 spans the upstream end of the heater 575.

Pyrolysis device 512 can also include a hydrogen inlet 583 for supplying hydrogen to the pyrolysis device 512. Hydrogen can be sourced from, for example, fuel processor 262 (FIG. 3). The addition of hydrogen to the pyrolysis device can bolster pyrolysis of the biomass in the pyrolysis device 512.

In some embodiments, all or a portion of the auger 570 and/or auger housing 573 is coated with catalytic compounds. These catalysts can be configured to augment the pyrolysis process within the pyrolysis device to deoxygenate the vapor within the device 512 and/or to produce favorable carbon chains within the vapor. In some embodiments, various catalysts are used to coat various portions of the auger 570 and/or housing 573. Example catalysts can include molybdenum (Mo)-based catalysts (e.g., Cobalt-Mo, Nickel-Mo, etc.). Use of Mo-based catalysts can provide a cheaper alternative to noble-metal based catalysts and other more expensive, difficult-to obtain catalysts.

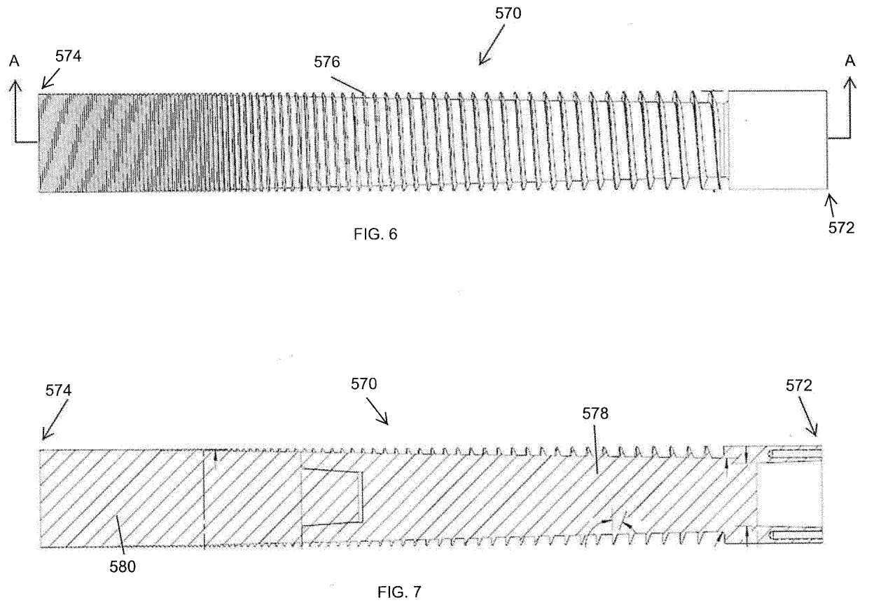

FIGS. 6 and 7 provide an isolated view of the auger 570 of pyrolysis device 512. As illustrated, the auger 570 can be formed from two or more separate portions. For example, the auger 570 can include an upstream segment 578 and a downstream segment 580. The two segments can be joined via threaded engagement 579 between the upstream and downstream segments 578, 580.

The depth of the blade 576 (e.g., the threads) of the auger 570, as measured from the core of the auger 570 to the tip of the blade 576 in a direction perpendicular to the rotational axis of the auger 570, can vary along the length of the auger 570. For example, a ratio between the depth of the blade 576 (e.g., the blade height) at the inlet end 572 can be greater than ten times, greater than 8 times, greater than 6 times, greater than 3 times, and/or greater than 1.5 times the depth of the blade 576 at or near the outlet end 574 of the auger 570. In some embodiments, the ratio of the max depth of the blade 576 and the minimum depth of the blade is between approximately 7:1 and approximately 18:1.

### Deoxygenation Device

The deoxygenation device of the systems described herein can be configured to deoxygenize the pyrolysis vapors at the increased pressure in the vapor phase without requiring condensation to bio-oil and subsequent vaporization of the bio-oil. The hydrocarbons, water, and/or light gases produced by the deoxygenation device can be directed to a condenser to condense out water, hydrocarbon fuels, and light gases. Some or all of the water can be directed to the gasifier to produce CO, H₂, and/or other desired compounds for use in components of the system to increase efficiency and to produce a higher yield of hydrocarbons. The deoxygenation device of the systems described herein can also be configured to utilize catalysts and mixing structures to convert the pyrolysis vapors into hydrocarbons, water, and/or fuel gas.

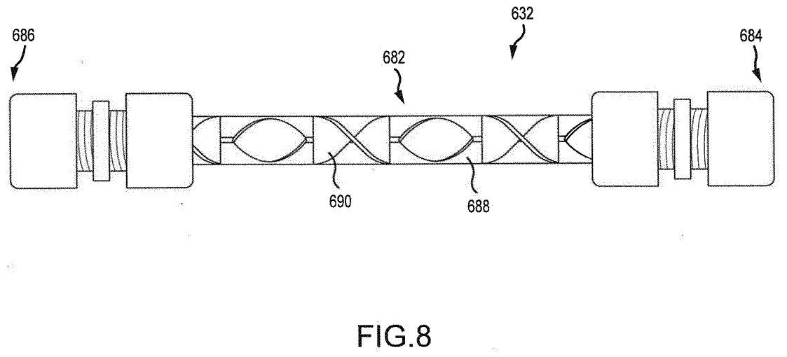

FIG. 8 illustrates a deoxygenation device 632. The deoxygenation devices and/or hydroprocessors described above with respect to FIGS. 1-4 can share some or all of the structural and/or functional characteristics of the deoxygenation device 632 described below.

As illustrated, the deoxygenation device 632 can include a processing portion 682 extending between an upstream end 684 and a downstream end 686. The upstream and downstream ends 684, 686 can be configured to connected to one or more mass transfer structures such as tubes, hoses, pipes, and/or other structures. The upstream end 684 can be configured to receive pyrolysis vapors from the pyrolysis device. The pyrolysis vapors can be received at the elevated pressures and temperatures realized downstream of the melt seal or other seal of the pyrolysis device.

The processing portion 682 of the deoxygenation device 632 can include a single tube 688. The tube 688 can be surrounded by a heat exchanger tube (not shown) or some other structure configured to control temperature of the tube 688. In some embodiments, one or more mixing structures 690 are provided within the tube 688. The mixing structures 690 can be, for example, fins, helixes, ribs, protrusions, or other physical structures positioned within the tube 688.

The tube 688 and/or mixing structures 690 can be coated and/or embedded with one or more catalysts configured to aid in the process of deoxygenating the pyrolysis vapor. The catalysts can be hydrotreating catalysts. In some embodiments, more than one catalyst is used. For example, a first catalyst can be used on an upstream portion of the tube 688 and/or mixing structures 690 and one or more additional catalysts of a different type can be used on portions of the tube 688 and/or mixing structure 690 downstream. Use of static components (e.g., the mixing structures 690 and tube 688) can facilitate easy replacement of portions of the deoxygenation device 632 when catalysts need to be reapplied and/or changed.

The mixing structures 690 can be configured to increase turbulence within the deoxygenation device 632. Increasing turbulence within the deoxygenation device 632 can increase mass transfer during the chemical reactions within the deoxygenation device 632. In some embodiments, the surface area of the mixing structures 690 is increased through use of fibrous, roughened, and/or porous material. For example, metal fiber sheets (e.g., sintered metal fiber sheets) can be used to form the mixing structures 690 and/or to cover the mixing structures 690. Example metal fiber materials include sintered metal fiber sheets manufactured by Bekaert® AISI 316L, Hastelloy C276, Inconel 600, and Hastelloy X. Other materials are also usable.

Use of high-surface area materials for the mixing structures 690 and/or tube 688 can increase the amount of catalysts that can be applied to the surfaces of the deoxygenation device 632. For example, atomic layer deposition may be used to deposit catalyst layers with precision. In some embodiments, the surfaces of the mixing structure 690 and/or the tube 688 can be decorated with nanoparticles (e.g., Nickel and/or Iron nanoparticles) to increase the ability of the mixing structures 690 and/or tube 688 to receive catalysts thereon. In some embodiments, portions of the deoxygenation device 632 are dipped or otherwise coated in suspensions containing nanoparticles. Increased catalyst content can increase the amount of usable hydrocarbons produced by the deoxygenation device 632. The resulting multi-scale composite of fibrous structures coated with catalyst materials can allow for a structurally-sound, highly efficient deoxygenation process within the deoxygenation device 632.

In some embodiments, use of the above-described multi-scale composites can allow for large fluid pathways through the deoxygenation device 632. Use of large pathways with static structures and/or few constrictions can allow the deoxygenation device 632 to be tolerant of the presence of bio-chars in the vapor mixture. Tolerating bio-chars can allow for use of the bio-chars to increase the efficiency of the deoxygenation device 632 and can reduce or eliminate the need to filter out the bio-chars from the output of the pyrolysis device.

Further increase in surface area within the deoxygenation device 632 can be realized through use of carbon nanotubes and/or nanofibers on the surfaces of one or both of the mixing structure 690 and the tube 688. The nanotubes/nanofibers can have very high surface areas (e.g., 200-1,100 m²/g) capable of being coated with catalyst materials. In some embodiments, the nanotubes and/or nanofibers can be doped with nitrogen to enhance catalytic activity.

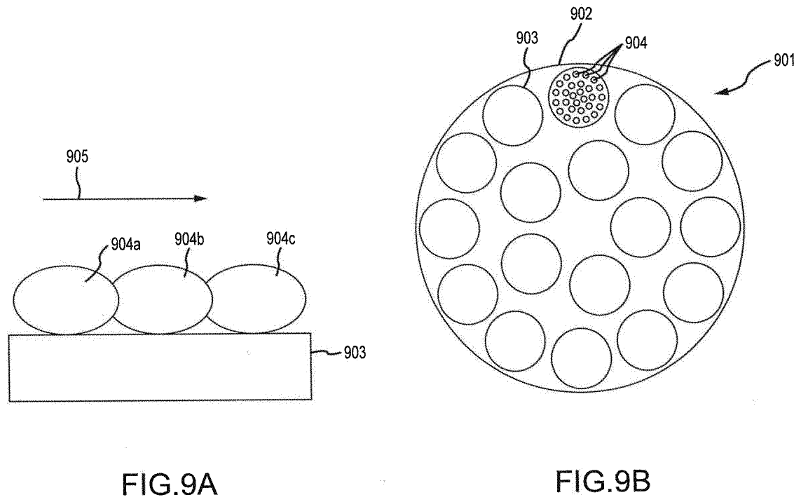

FIGS. 9A and 9B illustrate an embodiment of the deoxygenation device wherein multiple tubes 903 are disposed within the deoxygenation device and the tubes 903 are filled or coated with catalysts 904 to promote the deoxygenation reaction. These tubes 903 can be used as part of a shell and tube heat exchanger 901 so that heat produced by the deoxygenation reaction can be used in other parts of the system. In some embodiments, the tubes 903 are filled with different catalysts 904a, 904b, 904c, etc., along the length of the tube 903 to effect consecutive reactions in order to produce the desired final product molecules.

With reference to FIG. 9B, the shell and tube heat exchanger 901 that can be employed within the deoxygenation device generally includes an outer shell 902 in which a plurality of tubes 903 are disposed. Within the tubes 903, catalyst 904 is packed to fill some or all of the void space within the tubes 903. While not shown in FIG. 9B, catalyst can also be coated on the interior walls of the tubes 903. Pyrolysis vapors are passed though the length of the tubes 903, and deoxygenation reactions occur within the tubes 903. The deoxygenation reaction is initiated and/or promoted due to the presence of the catalyst 904. The tubes 903 do not fill all of the void space within the shell 902, and therefore channels are formed within the shell 902 but exterior to the tubes 902. Heat given off by the deoxygenation reaction can travel through the tubes and into the channels within the shell 902. If another material is passed through the channels (e.g., counter-currently to the direction that pyrolysis vapors pass through the tubes 903), then the material can be heated by the heat generated from the deoxygenation reaction.

With reference to FIG. 9A, the catalyst 904 can be loaded in the tube 903 in a manner such that the type of catalyst 904 changes along the length of the tube 903. By carefully calibrating the type of catalyst 904 used along the length of the tube 903, different reactions can be promoted at different points along the length of the tube 903. Thus, as the makeup of the pyrolysis vapor changes as it passes through the tube 903, the catalyst 904 can be altered to promote specific reactions based on, e.g., reactant expected to be available at different points along the length of the tube 903. FIG. 9A shows arrow 905 indicating the direction of flow of pyrolysis vapors through the tube 903. At a first region closer to the upstream side of the tube 903, catalyst 904a is provided to promote a first reaction. The result of the first reaction is a change in the types of material present at the intermediate portion of the tube 903. As such, a second catalyst 904b is provided at the intermediate portion of the tube 903, with the second catalyst 904b designed to promote a second reaction that requires reactants present in a higher amount or concentration due to the first reaction. Closer to a downstream end of the tube 903 is a third catalyst 904c. The third catalyst 904c is designed to promote a third reaction that requires reactants present in a higher amount or concentration due to the second reaction. Based on this configuration, the efficiency of the deoxygenation device is improved (for example, in terms of converting pyrolysis vapors to the desired end products). While FIG. 9A shows three different types of catalyst along the length of the tube 903, it should be appreciated that any number of different types of catalyst can be used within the tube 903.

The systems described herein can incorporate a pressure coupling that allows the pyrolysis device and the hydroprocessor (e.g., deoxygenation unit) to separate. This separation point allows access to both the pyrolysis unit and the hydroprocessor. For example, using the pressure coupling, catalyst can be replaced in the hydroprocessor by removing and replacing tubes in the shell when a shell and tube configuration is employed without impacting the pyrolysis device. Similarly, catalyst in, for example, a sulfur guard bed positioned between the pyrolysis device and the deoxygenation device (e.g., as shown in FIG. 4), can be removed without impacting the deoxygenation device.

### Carbon Efficiency

In some embodiments, use of the pyrolysis systems described above can allow for increased carbon efficiency as compared to prior art systems. For example, the above-recited systems can allow for the primary rejection product from the hydroprocessing and/or deoxygenation processes to be water in order to divert more of the carbon into hydrocarbons (e.g., as opposed to carbon dioxide). Hydrogen from the water can then be produced using byproduct carbon (e.g., char) in an integrated gasification process. An example of a theoretical mass balance is illustrated in the below reactions (amounts in megamoles):

0.23CH_{1.33}O_{0.56}+0.15H₂→0.16CH₂+0.12H₂O+0.07CH_{0.71}O_{0.09},

0.07H_{0.71}O_{0.09}+0.13H₂O→0.15H₂+0.07CO₂

In the above-recited reactions, approximately 5 tons/hour of biomass (0.225 megamoles of CH_{1.33}O_{0.56}) reacts with 0.3 tons/hour of H₂ to produce 2.2 tons/hour of hydrocarbons (e.g., CH₂ in this example) along with 2.1 tons of water and 0.9 tons of char (CH_{0.71}O_{0.09}). This means that 30% of the carbon in the feed biomass is rejected ultimately as carbon dioxide but 95% of the energy in the original biomass is retained in the produced hydrocarbon.

### Hydrogen Efficiency

The char yield noted in the above mass balance can be steam gasified with 2.3 tons of water to produce the required hydrogen along with 2.9 tons of carbon dioxide. In some embodiments, carbon monoxide can be fed to the pyrolysis device to incorporate water-gas shift in the pyrolysis step to produce additional H₂. The below illustrative reactions illustrate how carbon monoxide can be both used to generate hydrocarbons and produced by reacting char with carbon dioxide (e.g., with carbon dioxide produce in the formation of H₂ from char and water):

0.23CH_{1.33}O_{0.56}+0.11H₂+0.04CO→0.16CH₂+0.08H₂O+0.04CO₂+0.07H_{0.71}O_{0.09}

0.05CH_{0.71}O_{0.09}+0.09H₂O→0.11H₂+0.05CO₂

0.02CH_{0.71}O_{0.09}+0.02CO₂→0.01H₂+0.04CO

Each of the above-recited reactions illustrates how carbon and hydrogen can be recycled with the disclosed pyrolysis systems to increase overall hydrocarbon yield.

### Additional Examples

Several aspects of the present technology are set forth in the following examples:

1. A pyrolysis device comprising:
a housing having an inlet and an outlet; and
an auger positioned within the housing, the auger having:
   an upstream end adjacent the inlet of the housing;
   a downstream end adjacent the outlet of the housing;
   a core extending between the upstream end and the downstream end; and
   a helical blade wound around the core between the upstream end and the downstream end;
wherein:
   the inlet of the housing is configured to receive biomass; and
   the pyrolysis device is configured to convert the biomass to a pyrolysis vapor and to produce a pressure seal formed by material in transition between biomass and pyrolysis vapor, the pressure being seal positioned between the inlet of the housing and the outlet of the housing.

2. The pyrolysis device of claim 1, wherein the core of the auger is tapered from a first diameter at the upstream end to a second diameter at the downstream end, the first diameter being smaller than the second diameter.

3. The pyrolysis device of claim 2, wherein:
the helical blade has a blade height measured from an outer surface of the core in a direction perpendicular to a rotational axis of the core to a terminal end of the helical blade; and
the height of the helical blade varies from the upstream end to the downstream end of the auger.

4. The pyrolysis device of claim 3, wherein the height of the helical blade decreases from the upstream end to the downstream end.

5. The pyrolysis device of claim 4, wherein the height of the helical blade decreases at a rate proportional to the increase in the diameter of the core of the auger such that a distance between the terminal end of the blade and the rotational axis of the auger is substantially constant along the length of the auger.

6. The pyrolysis device of claim 1, further comprising:
a heater surrounding a portion of the auger between the inlet of the housing and the outlet of the housing.

7. The pyrolysis device of claim 1, wherein during operation:
a pressure within the housing between the inlet and the pressure seal is approximately atmospheric pressure; and
a pressure within the housing between the pressure seal and the outlet is at least 300 psia.

8. The pyrolysis device of claim 1, wherein the inlet of the housing is configured to receive biomass in the form of wood chips, sawdust, or a combination thereof.

9. The pyrolysis device of claim 1, further comprising a gas inlet for introducing gas into the housing.

10. The pyrolysis device of claim 1, wherein the gas inlet is in fluid communication with a carbon monoxide source or a hydrogen source.

11. A biomass processing system comprising:
a pyrolysis device configured to receive biomass, pyrolyze the biomass to produce pyrolysis vapors, and output the pyrolysis vapors; and
a deoxygenation device in fluid communication with the pyrolysis device, the deoxygenation device configured to receive the pyrolysis vapors and deoxygenate the pyrolysis vapors to produce a deoxygenation product stream comprising at least two of water, hydrocarbons, and fuel gas.

12. The biomass processing system of claim 11, wherein deoxygenating the pyrolysis vapors is performed without condensing the pyrolysis vapors to bio-oil.

13. The biomass processing system of claim 11, wherein the pyrolysis device outputs pyrolysis vapors at a pressure of at least 300 psia.

14. The biomass processing system of claim 11, wherein pyrolyzing the biomass further produces char, and the system further comprises a filter in fluid communication with the pyrolysis device, the filter being configured to separate the char from the pyrolysis vapors.

15. The biomass processing system of claim 14, further comprising:
a separator in fluid communication with the deoxygenation device, the separator configured to separate the deoxygenation product stream into a water stream, a hydrocarbons stream, and a fuel gas stream.

16. The biomass processing system of claim 15, further comprising:
a gasifier in fluid communication with the separator, the gasifier configured to receive the water stream produced by the separator and the char produced by the filter and produce a hydrogen stream and a carbon monoxide stream.

17. The biomass processing system of claim 16, wherein the pyrolysis device is in fluid communication with the gasifier and the pyrolysis device is configured to receive the carbon monoxide stream.

18. The biomass processing system of claim 16, wherein the deoxygenation device is in fluid communication with the gasifier and the deoxygenation device is configured to receive the hydrogen stream.

19. The biomass processing system of claim 15, wherein the separator comprises a cyclone.

20. The biomass processing system of claim 11, further comprising:
a filter in fluid communication with the pyrolysis device, the filter being configured to separate sulfur from the pyrolysis vapors.

21. A deoxygenation device comprising:
an inlet;
an outlet;
a housing extending between the inlet and the outlet;
one or more mixing structures positioned within the housing between the inlet and the outlet, the mixing structures; and
a catalyst material deposited within the housing, the catalyst being configured to promote a deoxygenation reaction.

22. The deoxygenation device of claim 21, wherein the one or more mixing structures comprises one or more metal fiber sheets upon which carbon nanotubes, carbon nanofibers, or both are deposited.

23. The deoxygenation device of claim 22, wherein the catalyst is deposited on one or more of an interior surface of the housing, the one or more mixing structures, and the carbon nanotubes and/or carbon nanofibers.

24. The deoxygenation device of claim 21, further comprising:
a shell and tube heat exchanger located within the housing, the shell and tube heat exchanger comprising a plurality of tubes, wherein the catalyst is packed within each of the plurality of tubes.

25. The deoxygenation device of claim 24, wherein each tube comprises a upstream end and a downstream end, and wherein a first type of catalyst configured to promote a first reaction is packed proximate the upstream end and a second type of catalyst configured to promote a second reaction is packed proximate the upstream end.

26. A method of processing biomass, comprising:
pyrolyzing biomass to produce char and pyrolysis vapors;
separating the char from the pyrolysis vapors;
deoxygenating the pyrolysis vapors to produce a deoxygenation product stream, the deoxygenation product stream comprising water, hydrocarbons and fuel gas;
separating the deoxygenation product stream into water, hydrocarbons and fuel gas, and gasifying the char and the water to produce hydrogen and carbon monoxide.

27. The method of claim 26, further comprising:
using the hydrogen in deoxygenating the pyrolysis vapors.

28. The method of claim 26, further comprising:
using the carbon monoxide in pyrolyzing the biomass.

29. The method of claim 26, further comprising:
condensing the deoxygenation product stream prior to separating the deoxygenation product stream.

30. The method of claim 26, further comprising:
processing the fuel gas to separate hydrogen from the fuel gas.

31. The method of claim 30, further comprising:
burning the fuel gas to drive the pyrolysis of the biomass.

32. The method of claim 26, further comprising:
separating sulfur from the pyrolysis vapors prior to deoxygenating the pyrolysis vapors.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. Moreover, the various embodiments described herein may also be combined to provide further embodiments. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A pyrolysis device comprising:
a housing having an inlet and an outlet; and
an auger positioned within the housing, the auger having:
an upstream end adjacent the inlet of the housing;
a downstream end adjacent the outlet of the housing;
a core extending between the upstream end and the downstream end; and
a helical blade wound around the core between the upstream end and the downstream end;
wherein:
the inlet of the housing is configured to receive biomass; and
the pyrolysis device is configured to convert the biomass to a pyrolysis vapor and to
produce a pressure seal formed by material in transition between biomass and pyrolysis vapor, the pressure being seal positioned between the inlet of the housing and the outlet of the housing.

2. The pyrolysis device of claim 1, wherein the core of the auger is tapered from a first diameter at the upstream end to a second diameter at the downstream end, the first diameter being smaller than the second diameter.

3. The pyrolysis device of claim 2, wherein:
the helical blade has a blade height measured from an outer surface of the core in a direction perpendicular to a rotational axis of the core to a terminal end of the helical blade; and
the height of the helical blade varies from the upstream end to the downstream end of the auger.

4. The pyrolysis device of claim 3, wherein the height of the helical blade decreases from the upstream end to the downstream end.

5. The pyrolysis device of claim 4, wherein the height of the helical blade decreases at a rate proportional to the increase in the diameter of the core of the auger such that a distance between the terminal end of the blade and the rotational axis of the auger is substantially constant along the length of the auger.

6. The pyrolysis device of claim 1, further comprising:
a heater surrounding a portion of the auger between the inlet of the housing and the outlet of the housing.

7. The pyrolysis device of claim 1, wherein during operation:
a pressure within the housing between the inlet and the pressure seal is approximately atmospheric pressure; and
a pressure within the housing between the pressure seal and the outlet is at least 300 psia.

8. The pyrolysis device of claim 1, wherein the inlet of the housing is configured to receive biomass in the form of wood chips, sawdust, or a combination thereof.

9. The pyrolysis device of claim 1, further comprising a gas inlet for introducing gas into the housing.

10. The pyrolysis device of claim 1, wherein the gas inlet is in fluid communication with a carbon monoxide source or a hydrogen source.

11-20. (canceled)
